(19) United States
(12) Patent Application Publication
(10) Pub. No.: US 2002/0027929 A1
(43) Pub. Date: Mar. 7, 2002

(54) System and method for mapping signals to a data structure having a fixed frame size

(76) Inventor: John Eaves, Middletown, NJ (US)

Correspondence Address: Daniel N. Daisak, TyCom, Inc., 250 Industrial Way West, Eatontown, NJ, 07724, US

(21) Appl. No.: 09/883,147

(22) Filed: Jun. 15, 2001

Related U.S. Application Data
(60) Provisional application No. 60/211,681, filed on Jun. 15, 2000.

(51) Int. Cl. G06F 7/00

(52) U.S. Cl. 370/505; 370/498; 370/386

(57) ABSTRACT

A method and apparatus for mapping digital data signals in an optical communication system to a data structure having a fixed frame size. A justification indicator and a negative stuff location are allocated in frame overhead to accommodate positive/negative/zero justification. A multiplexing method to establish a hierarchy of such data structures using the same technique is also described.

### CROSS REFERENCE TO RELATED APPLICATIONS

The present application claims the benefit of U.S. Provisional application serial number 60/211,681, filed Jun. 15, 2000, the teachings of which are incorporated herein by reference.

### FIELD OF THE INVENTION

The invention relates to communications networks in general. More particularly, the invention relates to a method and apparatus for mapping data signals in an optical communication system to a data structure having a fixed frame size.

### BACKGROUND OF THE INVENTION

Wavelength division multiplexed optical networks (WDM) have typically been adapted for communication of SONET/SDH formatted signals. Various schemes have been developed for multiplexing and transmitting a plurality of these signals as an aggregate signal on a single fiber path. The SONET/SDH standards accommodate multiplexing using a frame of fixed time period but with frame length that is dependant on bit rate. For example, a plurality signals having a first frame size may be multiplexed and mapped to a SONET/SDH frame having a larger frame size sufficient to accommodate the data in the multiplexed signals. This methodology has worked well, but has introduced some practical difficulties associated with network design. In particular, network hardware and software must be configured to accommodate the anticipated frame structures transmitted on the network. This becomes cumbersome with changes in network configuration. The method used in SONET/SDH also increases the absolute amount of frame overhead in the higher-level signals. For very high bit rates, this can increase the transmission impairments which scale with increasing bit rate.

To address this issue, it has been proposed to establish a standardized data structure for communication on an optical network wherein frames in the standardized structure have a fixed size, but decreasing period for accommodating higher data rates. In general, such a standardized data structure may include a hierarchal scheme whereby data transmitted on various portions of the network is formatted in an associated frame having associated “overhead” and “payload” configurations. The frames transmitted at successive higher data rates may have a shorter period than previous frames and may include the payload and some portion of the overhead associated with previous frames. An example of such a data structure is described in detail in the Draft New Recommendation G.7.09 approved by the International Telecommunication Union (ITU)-Telecommunication Standardization Sector in its Feb. 5-9, 2001 Geneva meeting.

The fixed frame size structure alleviates many of the interoperability issues associated with formats, such as SONET/SDH, wherein frame size varies. A difficulty arises, however, when a data signal to be mapped into a fixed frame size data structure is be transmitted with a data clock operating at a somewhat different rate than a clock associated with mapping the data signal to the data structure. The data bytes may not map directly into desired locations in the data structure. This becomes cumbersome to deal with from the standpoint of determining where portions of the data signals begin and end within a particular frame of the fixed frame size structure.

There is therefore, a need in the art for a system and method of efficiently and reliably mapping one or more data signals into a fixed frame size data structure that overcomes the deficiencies of the prior art associated with discrepancies between the data signal clock and a mapping clock.

### SUMMARY OF THE INVENTION

According to one aspect of the invention, there is provided a method of mapping a data signal to a data frame structure having a fixed frame size. The method includes: identifying a stuff condition for the data frame in response to a difference between a data clock for the data signal and a mapping clock for the data frame; allocating a justification indicator (JI) location in an overhead section of the frame for indicating the stuff condition; and allocating a negative stuff (NS) location in the overhead for receiving negative stuff data. A computer readable medium for causing a computer system to perform a mapping operation consistent with the invention is also provided.

According to another aspect of the invention, there is provided a method of multiplexing a plurality of data signals having a fixed frame size into a data frame having the same frame size. The method includes identifying a stuff condition for the data frame in response to a difference between a data clock for at least one of the data signals and a mapping clock for the data frame; allocating a justification indicator (JI) location in an overhead section of the data frame for indicating the stuff condition; and allocating a negative stuff (NS) byte in the overhead for receiving negative stuff data. A computer readable medium for causing a computer system to perform a multiplexing operation consistent with the invention is also provided.

With these and other advantages and features of the invention that will become hereinafter apparent, the nature of the invention may be more clearly understood by reference to the following detailed description of the invention, the appended claims and the several drawings attached herein.

### BRIEF DESCRIPTION OF THE DRAWINGS

FIG. 1 illustrates an exemplary WDM system suitable for practicing one embodiment of the invention.

FIG. 2 illustrates, in diagrammatic form, an exemplary frame structure consistent with the invention.

FIG. 3 is a block flow diagram of an exemplary method consistent with the invention.

FIG. 4 illustrates, in diagrammatic form, an exemplary ODUk frame structure useful in connection with the present invention.

FIG. 5 illustrates, in diagrammatic form, an overhead section of the ODUk frame structure illustrated in FIG. 4.

### DETAILED DESCRIPTION

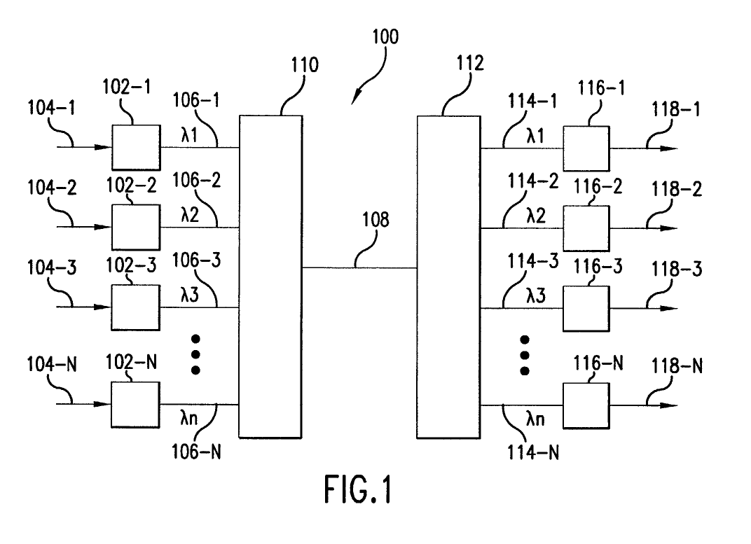

FIG. 1 shows a simplified block diagram of an exemplary wavelength division multiplexed (WDM) transmission system 100 consistent with the present invention. The transmission system serves to transmit a plurality of optical channels over an optical information channel from a transmitting terminal to one or more remotely located receiving terminals. Those skilled in the art will recognize that the system 100 has been depicted as a highly simplified point-to-point system form for ease of explanation. It is to be understood that a system and method consistent with the invention may be incorporated into a wide variety of network components and configurations.

In the illustrated exemplary embodiment, each of plurality of transmitters 102-1, 102-2, 102-3 . . . 102-N receives a data signal on an associated input port 104-1, 104-2, 104-3, 104-N, and transmits the data signal on associated wavelength λ₁, λ₂, λ₃, . . . λ_{N}. The transmitted wavelengths or channels are respectively carried on a plurality of paths 106-1, 106-2, 106-3, 106-N. The data channels are combined into an aggregate signal on an optical information channel 108 by a multiplexer or combiner 110. The optical information channel 108 may include an optical fiber waveguide, optical amplifiers, optical filters, dispersion compensating modules, and other active and passive components.

The aggregate signal may be received at one or more remote receiving terminals 104. A demultiplexer separates the transmitted channels at wavelengths λ₁, λ₂, λ₃, . . . λ_{N} onto associated paths 114-1, 114-2, 114-3, 114-N coupled to associated receivers 116-1, 116-2, 116-3, 116-N. Depending on system requirements, the receivers may recreate the data signals from the received channels and provide the data signals on associated output paths 118-1, 118-2, 118-3, 118-N.

Consistent with the present invention, communication of signals on the optical system 100 may be accomplished via a data structure having a fixed frames size, but varying period for accommodating varying data rates. For example, a hierarchal data structure, such as that proposed by the ITU in its aforementioned G.709 standard, may be used. In the hierarchal scheme, data communication on various portions of the network may be based on a fixed frame size, but the frame period may vary to accommodate varying data rates. For example, higher levels of the hierarchy for communicating multiplexed data frames may be formatted with the same frame size as the multiplexed data frames, but the frame may have a shorter period than the multiplexed frames.

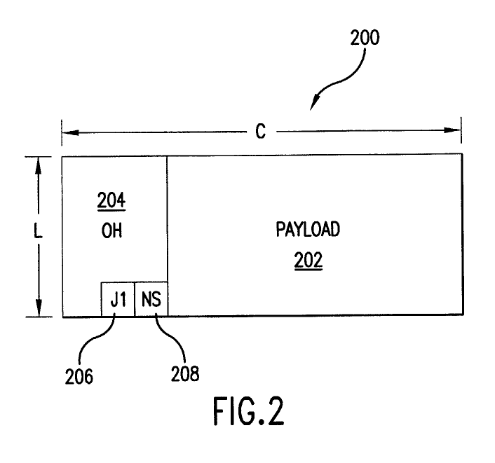

Turning now to FIG. 2, there is illustrated an exemplary data frame structure 200 consistent with the invention. As shown, the frame has a defined number of columns c and a defined number of rows r. This basic frame size may be used for communications on all portions of the network 100, for example, but the frame period may vary depending on data rate.

The illustrated frame structure includes a payload section 202 and an overhead section 204. Those skilled in the art will recognize that the overhead section 204 may include information for maintenance and operational functions associated with the frame, and that the payload section 202 may include the information carrying data to be transmitted on the network. In the frame 200, the overhead section has been indicated in simplified form for ease of explanation. Depending on the location in the network where the frame is to be transmitted, the actual content of the overhead section may vary. For example, in a lower level of a hierarchal structure, e.g. at the output of a transmitter 102-1, the overhead section may include only overhead associated with the frame, but at a higher level, e.g. at the output of the multiplexer 110, the frame overhead section may include overhead for the frame as well as locations for mapping overhead associated with multiplexed frames.

The exemplary frame structure 200 includes locations 206, 208 in its overhead 204 used to accommodate discrepancies between the clock associated with data to be mapped into the frame and the clock for mapping the data. For example, in the case where a data signal, e.g. a client signal, received on line 104-1 is to be mapped by the transmitter 102-1 into a frame structure 200, the data signal clock may operate at a frequency slightly different from the transmitter clock for mapping data into the frame 200. In this case, positive or negative stuffing of the frame 200 may be required.

Those skilled in the art will recognize that positive stuffing refers to a process of adding dummy information into a frame location, and negative stuffing refers to moving data to an alternate location when an insufficient number of frame locations are available for accommodating the data to be mapped into a frame. For example, if a data signal clock is slower than a mapping clock for mapping data into a frame, then positive stuffing may be required since the frame is capable of accommodating more data than is being clocked into the frame. Positive stuffing may be accomplished by inserting dummy data into the unused frame locations. On the other hand, when the data clock is faster than the mapping clock, then more data accumulates faster than it can be placed into a frame location. Thus, negative stuffing may be required, whereby data that cannot be placed in a frame overhead location is placed in an alternate location. It is also possible that the data clock and the mapping clock are sufficiently similar so as to require no stuffing. This is referred to as a “zero” stuff condition.

The locations 206, 208 in the overhead 204 of the frame 200 are provided for accommodating positive, negative, and zero stuff conditions of the associated payload 202. Location 206 may be assigned as a negative stuff (NS) location, and location 208 may be assigned as a justification indicator (JI) location. Although in the illustrated embodiment locations 206 and 208 are shown as being adjacent each other in the same row, this need not be the case. In fact, the locations 206 and 208 may be placed in any available location, e.g. in a reserved area of the overhead. In addition, although only one NS and one JI byte are shown, it is possible to use multiple bytes for each of these functions.

In general, the value in the JI location may indicate a positive, negative, or zero stuff condition. In the event of positive and zero stuff conditions, demapping of the signal is accomplished with knowledge of the condition via the JI location. When negative stuffing is required, then this condition is indicated by the JI location and negative stuff data may be mapped into the NS location. When the frame is demapped, the negative stuff data may be removed from the NS location to recreate the data signal.

Advantageously, a data structure with a fixed frame size and positive/negative/zero justification, such as exemplary structure 200, may be utilized throughout a data structure hierarchy to facilitate communication and/or multiplexing of signals from one hierarchal level to another. Of course, the period of the frames and the overhead location assignments may vary from one hierarchal level to another. Nonetheless, using a fixed frame size in a multiplexing hierarchy in a manner consistent with the invention, allows for standardization of interfaces in an optical network, leading to enhanced interoperability and reliability of network components.

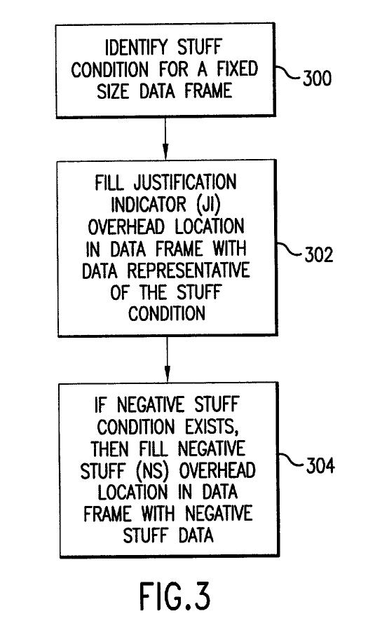

In an exemplary method consistent with the invention, therefore, mapping of a data signal into a fixed frame size data structure may be accomplished, as illustrated in FIG. 3, by identifying 300 the stuff condition for the frame, i.e. positive, negative, or zero. The stuff condition is indicated by filling 302 a justification indicator (JI) of the data frame with data representative of the condition. In the event that negative stuffing is required, then the negative stuff location (NS) of the frame overhead is filled 304 with negative stuff data. Other hierarchal levels in the network data structure may use a similar method to facilitate multiplexing and/or communication of the data signals.

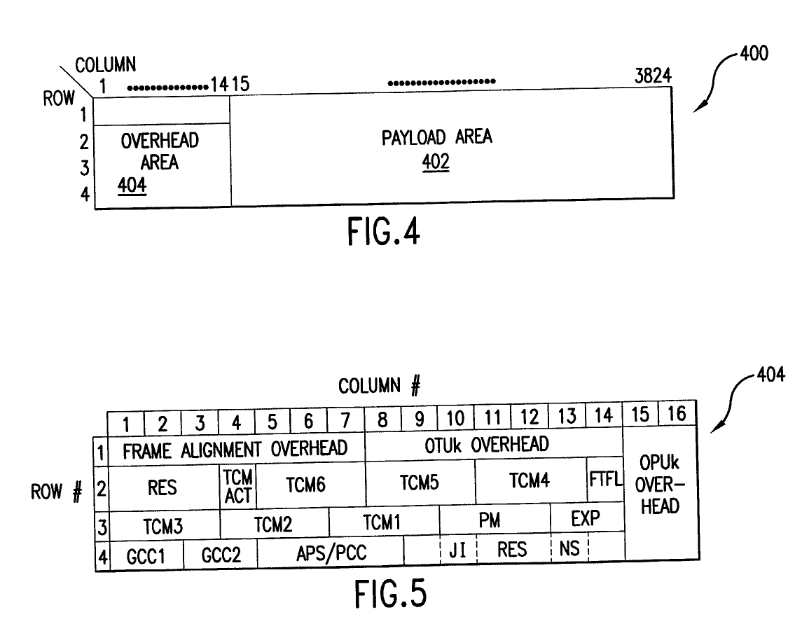

Turning now to FIG. 4, there is shown another exemplary embodiment of a frame structure 400 useful in connection with the present invention. The frame structure 400 is the optical channel data unit k (ODUk) frame structure portion of the hierarchal structure described in the aforementioned G.709 proposal by the ITU. As will be described in greater detail below, reserved locations in the ODUk may be used as JI and NS locations in a manner consistent with the invention to facilitate multiplexing and/or mapping of data signals in to ODUk-formatted signals.

As shown in FIG. 4, the ODUk frame structure 400 has a fixed frame size of 3824 columns and 4 rows. The frame structure 400 includes a payload section 402 and an overhead section 404. The overhead section is illustrated in greater detail in FIG. 5. There are six bytes currently unassigned in the ODUk overhead area, identified as the RES location at the fourth row of FIG. 5, bytes (4,9)-(4,15). ODUk capacities for k=1, k=2, and k=3 have been defined. Primarily to accommodate SDH signals, ODU1 is about 2.5 Gb/s, ODU2 is about 10 Gb/s, and ODU3 is about 40 Gb/s. Again, however, the frame size for each ODUk is the same. Thus the period for ODU1 is about 48.97119 . . . μs, the period for ODU2 is about 12.19157 . . . μs, and the period for ODU3 is about 3,03514 . . . μs.

A positive/negative/zero (pnz) technique consistent with the invention may be used to keep the ODUk bit rate reasonably low, compared to traditional SONET/SDH justification and positive-only justification methods, when adapting SDH clients to the OTN hierarchy and for multiplexing ODUks with frame format given in FIG. 4. This is important for high bit rate signals because the effects of transmission impairments, e.g. chromatic and polarization mode dispersion, generally increase with transmission bit rate. Multiplexing ODUks and mapping data signals into ODUks in a manner consistent with the invention will be described in detail below. The following embodiments include ODUk rates (k-1, 2, 3) based on the assumption that OTN data signals (i.e. client signals) are predominantly SDH-based. It is to be understood, however, that the present invention is not limited to the described embodiment, but that it is general and may be applied to any integrally related client or data signal hierarchy.

Multiplexing of ODUks into higher order ODUs may be accomplished in a manner consistent with the invention by utilizing a portion of the available ODUk overhead for justification control and negative stuff. This approach enables both hierarchical and flat multiplex architectures for multiplexing ODUks. In particular, within the available ODUk overhead reserved for standardization identified as RES in the last row in FIG. 5, one byte may be assigned as a negative stuff location byte NS and one byte may be assigned as a justification indicator byte JI.

In one embodiment, the JI byte may be partitioned into a 4-bit stuff indicator. The remaining 4 bits of JI may be left available for other purposes. Depending on the stuff condition of the associated frame, the 4-bit stuff indicator of JI may be set as follows:

1010=no stuffing in the associated frame;

0000=negative stuffing/justification in the associated frame. The extra information byte, i.e. the negative stuff data, is mapped to the NS byte of associated frame; and

1111=positive stuffing/justification in the associated frame, i.e. a specified byte location within the frame payload area following the occurrence of JI is stuffed with dummy data (e.g. 10101010). In this case, NS may also be filled with dummy data.

The exact location for the JI and NS bytes in the reserved RES overhead is not critical. As illustrated in FIG. 5, for example, JI may be assigned as byte (4,10) and NS may be to byte (4,16). Advantageously, the JI byte may occur before the NS byte so that justification may be performed in the same frame as the JI byte that indicates a requirement for justification action. In addition, although only one NS byte is described in connection with the exemplary embodiments illustrated herein, additional bytes for negative stuff (NS) may be allocated from the unassigned bandwidth of the frame overhead (with related expansion of size of the indicator JI).

With the above described exemplary arrangement, i.e. one JI byte and one NS byte in an ODUk frame, the maximum timing deviation between the data clock and the clock for mapping the data into the ODUk frame that will allow effective use of the negative stuff (NS) position is given by:

$$\frac{1}{4 \times 3808} = 65 ppm \qquad ( 1 )$$

Positive stuff in the same amount can also be accommodated within the ODUk payload area. Consequently, the clock deviation accommodated is ±65 parts per million (ppm). This is the relative timing deviation between an ODUk and its adapted client(s) data signals. If an adapted client signal has ±20 ppm and the ODUk has ±20 ppm timing deviation, then the resulting ±40 ppm relative timing deviation can be accommodated by a pnz method consistent with the invention.

A pnz method consistent with the invention may also be used to adapt/map client data signals into an ODUk frame format. In the case of adapting STM-N data signal(s) into ODUk frame format, the requirement that the payload area of the ODUk (plus the NS byte for negative stuffing) accommodate its related STM-N signal under relative timing offsets of the ODUk and STM-N clocks requires the following relationship to hold:

$$\frac{32 ( 3808 ) - 8 {N}_{k} + 8 {α}_{k}}{{T}_{k}} = {S}_{k} \times β \qquad ( 2 )$$

where Nₖ is the number of fixed stuff (FS) bytes required to be inserted into the ODUk payload area, αₖ is the stuff ratio associated with the occurrence of the positive/negative justification, Sₖ is the bit rate of the STM level related to ODUk (i.e. S₁=STM-16, S₂=STM-64, S₃=STM-256), and β is a parameter accounting for the range ±20 ppm in each of the Sₖ and ODUk clocks. Tₖ is the period of the ODUk signal.

Assuming worst-case conditions of the maximum timing deviations between the ODUk and STM-N clocks gives:

β_{L}≦β≦β_{H} β_{L}=0.99996 β_{H}=1.00004 (3)

,where β_{L} is the low limit for β and β_{H} is the high limit for β.

The value β=1 corresponds to operation at the nominal bit rates of both the ODUk and Sₖ clocks. When 1≧α>0 negative stuffing is used (i.e. the NS byte carries payload information), and when −1≦α<0 positive stuffing is occurring in the ODUk payload area. The value of α may be restricted to α≧−1 to avoid the necessity of an additional indicator byte to show the possible presence of more than one positive stuff byte per ODUk frame.

Solving Eq. 2 gives the following expression for the stuff ratio αₖ

$${α}_{k} = {N}_{k} + 4 ( 3808 ) ( {β ( \frac{238}{239} )}^{k - 1} - 1 ) \qquad ( 4 )$$

,which gives the results illustrated in Table 1 for adapting STMₖ levels into ODUk.

TABLE 1

| | | αₖ | | |
|---|---|---|---|---|
| k | Nₖ | β_{L} | β = 1 | B_{H} |
| 1 | 0 | −0.60928 | 0 | +0.60928 |
| 2 | 64 | −0.33895 | +0.26778 | +0.87451 |
| 3 | 127 | −0.80197 | −0.19777 | +0.40642 |

In view Table 1, for adapting STM-16 into ODU1, the case β=1 is obtained if the ODU1 clock is derived from the STM-16 clock (bit synchronous operation). For ODU2, the 64 FS bytes may be arranged as 16 columns of fixed stuff bytes evenly spaced in the ODU2 payload area. Referring to the column numbering shown in FIG. 4, the ODU2 column numbers containing the FS bytes are then given by:

C(i)=17+238(i−1), i=1, . . . 16 (5)

Similarly, the 127 stuff bytes for ODU3 may be evenly spaced as 32 columns but with one byte of one column in one row designated for information. Consequently, the ODU3 row and column numbers C(i,j) containing the FS bytes may be given by:

C(1,j)=136+119(j−1), j=1, . . . 32 (6)

C(1,j)=17+119(j−1), i=2, 3, 4, j=1, . . . 32 (7)

C(1,17), the first byte of the ODU3 payload is assigned to carry payload information.

The effective 127 FS bytes per frame (average) may also be obtained through a 4-frame “super frame” approach in which 3ODU3 frames contain 32 columns of FS information and the following 1 ODU3 frame contains 31 columns of FS. The location of the 4th ODU3 frame in the super frame may be indicated the multi-frame alignment signal (MFAS byte), module 4. Similarly, Eq. (2) shows that 128 bytes of fixed stuff could be forced if, for example, 2 negative stuff byte locations were allocated in the ODUk overhead.

As indicated above, the system and method according to the present invention also facilitates multiplexing of ODUks into higher order ODUs. For example, in the case of multiplexing four ODUk frames into an ODU(k+1), with k=1 or 2 for the levels so far designated in the OTN hierarchy, the JI and NS bytes may be allocated cyclically to each ODUk every 4th ODU(k+1) frame. Byte stuffing may be used, and he MFAS counter, modulo 4 may set the phase.

In this case of multiplexing four ODUk frames into an ODU(k+1), the equivalence between ODU(k+1) payload area and the bandwidth of 4×ODUk under relative timing deviations of the ODU clocks requires the following relationship:

$$\frac{32 ( 3808 ) + 8 α}{{T}_{k + 1}} = 4 \times ( ODUk ) \times β \qquad ( 8 )$$

where α is the justification ratio and β is given by Eq. (3). Using the relationship

$${T}_{k + 1} = ( \frac{1}{4} ) ( \frac{238}{239} ) {T}_{k} \qquad ( 9 )$$

in equation (8) yields:

α=4(3808)(β−1) (10)

The results illustrated in Table 2 are thus obtained for multiplexing four ODUks into an ODU(k+1), when k=1,2.

TABLE 2

| | β₂ | β = 1 | βπ |
|---|---|---|---|
| α | −0.60928 | 0 | +0.60928 |

From Table 2, it is evident that the mapping and justification ratios for multiplexing for this case is the same as that obtained for adapting STM1 to ODU1. However, the α value in this case can vary by frame within the range of Table 2 according to the offset of the four independent ODUk clocks and the cyclical assignment of JI/NS as described above.

In another exemplary embodiment, wherein sixteen ODU1s are multiplexed into an ODU3, the JI and NS bytes may be allocated cyclically to each ODU1 every 16th ODU3 frame. Byte stuffing may be used, and the MFAS counter, modulo 16 may set the phase. Consistent with the invention, it is thus possible to define a flat multiplexing scheme in which the ODU1s are directly identifiable from the ODU3 frame. In particular, for multiplexing sixteen ODU1s into an ODU3, the payload area of ODU3 (plus possible NS bytes), including FS bytes, must be equivalent to the capacity of 16×ODU1 under relative timing offsets of the ODUk clocks. This requires:

$$\frac{32 ( 3808 ) - 8 N + 8 α}{{T}_{3}} = 16 \times ( ODU1 ) \times β \qquad ( 11 )$$

Using Eqs. (9) and

$${T}_{k + 1} = ( \frac{1}{4} ) ( \frac{238}{239} ) {T}_{k} \qquad ( 12 )$$

with

$${T}_{1} = \frac{32 \times 16 \times 238}{STM16} \qquad ( 13 )$$

yields:

$$α = N - 4 ( 3808 ) ( 1 - ( \frac{238}{239} ) β ) \qquad ( 14 )$$

The results illustrated in Table 3 are thus obtained for multiplexing sixteen ODU1s into an ODU3 with 64 stuff locations:

TABLE 3

| | αₖ | | |
|---|---|---|---|
| N | β_{L} | β = 1 | βπ |
| 64 | −0.33895 | +0.26778 | +0.87451 |

This is the same ODU frame organization and stuff ratio obtained for adapting STM-64 to ODU2. However, the a value in this case can vary by frame within the range of Table 3 according to the offset of the sixteen independent ODUk clocks and the cyclical assignment of JI/NS bytes as described above.

There is thus provided a system and method for mapping and/or multiplexing signals into a data frame structure having a fixed size, but varying period, using a pnz method. Advantageously, mapping and multiplexing in a manner consistent with the invention allows reasonably low bit rates, thereby avoiding undesired transmission impairments associated with high bit rates. In addition, a method consistent with the invention allows hierarchal bit rates, e.g. ODU1, ODU2, ODU3 rates, to be derived from a common clock source in a mathematical recursive manner. The clock rates of the hierarchal levels may be related to powers of rational fractions that can be derived from the ratio of total frame size to overhead size. Alternatively, a pnz justification method consistent with the invention allows the hierarchal rates to be rounded to a convenient value. In this case, the stuff ratio may be shifted slightly compared to the value used in a strict recursive method. Separate clocks for each hierarchal level may be used to accommodate rounding of the hierarchal bit rates.

It will be appreciated that the functionality described for the embodiments of the invention may be implemented in hardware, software, or a combination of hardware and software, using well-known signal processing techniques. If in software, a processor and machine-readable medium is required. The processor can be any type of processor capable of providing the speed and functionality required by the embodiments of the invention. For example, the processor could be a process from the Pentium® family of processors made by Intel Corporation, or the family of processors made by Motorola. Machine-readable media include any media capable of storing instructions adapted to be executed by a processor. Some examples of such media include, but are not limited to, read-only memory (ROM), random-access memory (RAM), programmable ROM, erasable programmable ROM, electronically erasable programmable ROM, dynamic RAM, magnetic disk (e.g. floppy disk and hard drive), optical disk (e.g. CD-ROM), and any other device that can store digital information. In one embodiment, the instructions are stored on the medium in a compressed and/or encrypted format.

As used herein, the phrase “adapted to be executed by a processor” is meant to encompass instructions stored in a compressed and/or encrypted format, as well as instructions that have to be compiled or installed by an installer before being executed by the processor. Further the processor and machine-readable medium may be part of a larger system that may contain various combinations of machine-readable storage devices through various I/O controllers, which are accessible by the processor and which are capable of storing a combination of computer program instructions and data. Finally, in another example, the embodiments were described in a communication network. A communication network, however, can utilize an infinite number of network devices configured in an infinite number of ways. The communication network described herein is merely used by way of example, and is not meant to limit the scope of the invention.

The embodiments that have been described herein are, thus, but some of the several which utilize this invention and are set forth here by way of illustration but not of limitation. It is obvious that many other embodiments, which will be readily apparent to those skilled in the art, may be made without departing materially from the spirit and scope of the invention.

What is claimed is:

1. A method of mapping a data signal to a data frame structure having a fixed frame size, said method comprising:
identifying a stuff condition for said data frame in response to a difference between a data clock for said data signal and a mapping clock for said data frame;
allocating a justification indicator (JI) location in an overhead section of said frame for indicating said stuff condition; and
allocating a negative stuff (NS) location in said overhead for receiving negative stuff data.

2. A method according to claim 1, wherein said stuff condition is a positive stuff condition.

3. A method according to claim 1, wherein said stuff condition is a positive stuff condition, and wherein said method further comprises stuffing dummy data into a payload section of said data frame.

4. A method according to claim 1, wherein said stuff condition is a zero stuff condition.

5. A method according to claim 1, wherein said stuff condition is a negative stuff condition.

6. A method according to claim 1, wherein said stuff condition is a negative stuff condition, and wherein said method further comprises inserting said negative stuff data into said NS location.

7. A method according to claim 1, wherein said JI location comprises one byte of said overhead.

8. A method according to claim 1, wherein said JI location comprises four bits of said overhead.

9. A method according to claim 1, wherein said NS location comprises one byte of said overhead.

10. A method according to claim 1, wherein said data signals comprise ODUk-formatted signals.

11. A method according to claim 1, wherein said data frame comprises an ODUk-formatted frame.

12. A method of multiplexing a plurality of data signals having a fixed frame size into a data frame having said fixed frame size, said method comprising:
identifying a stuff condition for said data frame in response to a difference between a data clock for at least one of data signals and a mapping clock for said data frame;
allocating a justification indicator (JI) location in an overhead section of said data frame for indicating said stuff condition; and
allocating a negative stuff (NS) byte in said overhead for receiving negative stuff data.

13. A method according to claim 12, wherein said data frame has a shorter period than a period of each of said data signals.

14. A method according to claim 12, wherein said stuff condition is a positive stuff condition.

15. A method according to claim 12, wherein said stuff condition is a positive stuff condition, and wherein said method further comprises stuffing dummy data into a payload section of said data frame.

16. A method according to claim 12, wherein said stuff condition is a zero stuff condition.

17. A method according to claim 12, wherein said stuff condition is a negative stuff condition.

18. A method according to claim 12, wherein said stuff condition is a negative stuff condition, and wherein said method further comprises inserting said negative stuff data into said NS location.

19. A method according to claim 12, wherein said JI location comprises one byte of said overhead.

20. A method according to claim 12, wherein said JI location comprises four bits of said overhead.

21. A method according to claim 12, wherein said NS location comprises one byte of said overhead.

22. A method according to claim 12, wherein said data signals comprise ODUk-formatted signals.

23. A method according to claim 12, wherein said data frame comprises an ODUk-formatted frame.

24. A method according to claim 12, wherein said data signals comprise ODUk-formatted signals and said data frame comprises an ODU(k+1) formatted frame.

25. A method according to claim 12, wherein said data signals comprise ODU1 formatted signals and said data frame comprises an ODU3 formatted frame.

26. A machine-readable medium whose contents cause mapping by a computer system of a data signal to a data frame structure having a fixed frame size comprising:
identifying a stuff condition for said data frame in response to a difference between a data clock for said data signal and a mapping clock for said data frame;
inserting data indicating said stuff condition in a justification indicator (JI) location in an overhead section of said frame; and
inserting negative stuff data in a negative stuff (NS) location in said overhead in response to said stuff condition being a negative stuff condition.

27. A machine-readable medium according to claim 26, wherein said JI location comprises one byte of said overhead.

28. A machine-readable medium according to claim 26, wherein said JI location comprises four bits of said overhead.

29. A machine-readable medium according to claim 26, wherein said NS location comprises one byte of said overhead.

30. A machine-readable medium according to claim 26, wherein said data signals comprise ODUk-formatted signals.

31. A machine-readable medium according to claim 26, wherein said data frame comprises an ODUk-formatted frame.

32. A machine-readable medium whose contents cause multiplexing by a computer system of a plurality of data signals having a fixed frame size into a data frame having said fixed frame size comprising:
identifying a stuff condition for said data frame in response to a difference between a data clock for at least one of data signals and a mapping clock for said data frame;
inserting data indicating said stuff condition in a justification indicator (JI) location in an overhead section of said frame; and
inserting negative stuff data in a negative stuff (NS) location in said overhead in response to said stuff condition being a negative stuff condition.

33. A machine-readable medium according to claim 32, wherein said JI location comprises one byte of said overhead.

34. A machine-readable medium according to claim 32, wherein said JI location comprises four bits of said overhead.

35. A machine-readable medium according to claim 32, wherein said NS location comprises one byte of said overhead.

36. A machine-readable medium according to claim 32, wherein said data signals comprise ODUk-formated signals.

37. A machine-readable medium according to claim 32, wherein said data frame comprises an ODUk-formatted frame.

38. A machine-readable medium according to claim 32, wherein said data signals comprise ODUk-formatted signals and said data frame comprises an ODU(k+1) formatted frame.

39. A method according to claim 32, wherein said data signals comprise ODU1 formatted signals and said data frame comprises an ODU3 formatted frame.
